(19) United States
(12) Patent Application Publication
(10) Pub. No.: US 2011/0026364 A1
(43) Pub. Date: Feb. 3, 2011

(54) Apparatus and method for estimating position using ultrasonic signals

(75) Inventors: Hyong Euk Lee, Yongin-si (KR); Won-Chul Bang, Seongnam-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 12/656,569

(22) Filed: Feb. 3, 2010

(30) Foreign Application Priority Data
Jul. 31, 2009 (KR) 10-2009-0070366

(51) Int. Cl. G01S 3/80

(52) U.S. Cl. 367/127

(57) ABSTRACT

A three-dimensional (3D) position estimation apparatus and method using ultrasonic signals may estimate a 3D position based on distances between two ultrasonic signal transmitters and an ultrasonic signal receiver, and direction angles where the ultrasonic signal receiver receives the ultrasonic signals. When the ultrasonic signal receiver moves on a fixed distance, the 3D position estimation apparatus and method may estimate the 3D position of the ultrasonic signal receiver based on the fixed distance and the direction angles where the ultrasonic signal receiver receives the ultrasonic signals.

### CROSS-REFERENCE TO RELATED APPLICATIONS

This application claims the benefit of Korean Patent Application No. 10-2009-0070366, filed on Jul. 31, 2009, in the Korean Intellectual Property Office, the disclosure of which is incorporated herein by reference.

### BACKGROUND

1. Field

Example embodiments relate to a three-dimensional (3D) position estimation apparatus and method, and more particularly, to an apparatus and method for measuring a 3D position using ultrasonic signals.

2. Description of the Related Art

Ultrasonic signals, among various other schemes, may be used to measure and estimate a three-dimensional (3D) position of a moving object or target. A distance may be calculated by measuring a time of flight (TOF) of ultrasonic signals that travel through the air at about 340 m/s, the speed of sound, from a transmitter to reach a receiver. When a sampling frequency of the receiver is greater than or equal to 340 kHz, the above distance measurement scheme of using the TOF of ultrasonic signals may have an accuracy of 1 mm. However, in the case of a light source/electromagnetic wave such as an infrared (IR), an ultra wideband (UWB), a radio frequency (RF), and the like, the sampling frequency may need to be about 300 GHz to result in the same accuracy as the ultrasonic signals using a sampling frequency of 340 kHz. Specifically, high system specifications may be required. Accordingly, the above distance measurement scheme using the ultrasonic signals may be effective in an inexpensive motion sensing application field or a motion sensing application field having a relatively low accuracy. A 3D position or a direction may be estimated using the distance measurement scheme using the ultrasonic signals.

Generally, a 3D position estimation apparatus may calculate a 3D position of a target using a triangulation scheme, based on distance information between at least three ultrasonic signal transmitters and the target. However, when a plurality of ultrasonic signal transmitters exists, the 3D position estimation apparatus may not simultaneously transmit ultrasonic signals due to interference between the ultrasonic signals. When the plurality of ultrasonic signal transmitters exists, the 3D position estimation apparatus may sequentially transmit the ultrasonic signals.

Accordingly, to estimate the 3D position of the target, it may take a relatively long time to obtain distance information associated with the at least three ultrasonic signal transmitters. In particular, when estimating a position of a frequently moving object, an error may increase.

For example, ultrasonic signals may travel a 3 meter (m) distance in about 0.01 seconds. Accordingly, when a position measurement target exists within 3 m, the 3D position estimation apparatus may need to sequentially transmit at least three ultrasonic signals and thus it may take at least 0.03 seconds to obtain distance information.

To solve an error occurring in a dynamic location estimation due to a sequential transmission from the at least three ultrasonic signal transmitters, each of the at least three ultrasonic signal transmitters may use a different frequency and an ultrasonic signal receiver may use a filter. However, due to a characteristic of a piezoelectric element, a number of transmit antennas may be limited. When a frequency interval is small, interference may also occur even when using a filter. Accordingly, a scheme of receiving ultrasonic signals using the filter is not generally adopted by a 3D position estimation apparatus that includes four or more ultrasonic signal transmitters. In addition, ultrasonic signal transmitters may need to be separated further from each other to decrease an error occurring in the position calculation using the triangulation scheme. Accordingly, when there is a need for a plurality of ultrasonic signal transmitters, a system may be enlarged and costs may also increase.

### SUMMARY

According to an aspect of one or more embodiments, there may be provided a three-dimensional (3D) position estimation apparatus, including a measurement unit to measure time of flights of ultrasonic signals received by an ultrasonic signal receiver, and received intensities of the ultrasonic signals, a calculator to calculate distances corresponding to the time of flights, and to calculate direction angles of the ultrasonic signal receiver with respect to the ultrasonic signals, and an estimator to estimate a 3D position of the ultrasonic signal receiver based on the distances and the direction angles.

The apparatus may further include a plurality of ultrasonic signal transmitters to sequentially transmit the ultrasonic signals at predetermined time intervals.

The apparatus may further include a plurality of ultrasonic signal transmitters to simultaneously transmit the ultrasonic signals at different frequencies. The ultrasonic signal receiver may receive the simultaneously transmitted ultrasonic signals and separate the received ultrasonic signals using a frequency filter.

The calculator may calculate the direction angles based on the distances, the received intensities, and an ultrasonic signal characteristic, the ultrasonic signal characteristic being a variation of a received intensity depending on a direction of a corresponding ultrasonic signal.

Upon two 3D positions of the ultrasonic signal receiver corresponding to the distances and the direction angles being estimated, the estimator may estimate the 3D position to be within a predetermined area.

According to another aspect of one or more embodiments, there may be provided a 3D position estimation apparatus, including, a measurement unit to measure received intensities of ultrasonic signals received by an ultrasonic signal receiver, a calculator to calculate direction angles of the ultrasonic signal receiver with respect to the ultrasonic signals, and an estimator to estimate a 3D position of the ultrasonic signal receiver based on a fixed distance and the direction angles.

The apparatus may further include a plurality of ultrasonic signal transmitters to sequentially transmit the ultrasonic signals at predetermined time intervals.

The apparatus may further include a plurality of ultrasonic signal transmitters to simultaneously transmit the ultrasonic signals at different frequencies. The ultrasonic signal receiver may receive the simultaneously transmitted ultrasonic signals and separate the received ultrasonic signals using a frequency filter.

The calculator may calculate the direction angles based on the fixed distance, the received intensities, and an ultrasonic signal characteristic, the ultrasonic signal characteristic being a variation of a received intensity depending on a direction of a corresponding ultrasonic signal.

Upon two 3D positions of the ultrasonic signal receiver corresponding to the fixed distance and the direction angles being estimated, the estimator may estimate the 3D position to be within a predetermined area.

The estimator may estimate the 3D position of the ultrasonic signal receiver as any one among left, right, up, and down based on a reference point on the fixed distance.

The estimator may sense a predetermined repeated operation of moving left, right, up, and down within the fixed distance, to measure or correct in real time a relational expression between the predetermined repeated operation and one of the direction angles of the ultrasonic signal receiver prior to the estimating, and may estimate the 3D position of the ultrasonic signal receiver using the relational expression.

According to still another aspect of one or more embodiments, there may be provided a 3D position estimation method, including measuring time of flights of ultrasonic signals received by an ultrasonic signal receiver, and received intensities of the ultrasonic signals, calculating distances corresponding to the time of flights, calculating direction angles of the ultrasonic signal receiver with respect to the ultrasonic signals, and estimating a 3D position of the ultrasonic signal receiver based on the distances and the direction angles.

The calculating of the direction angles may include calculating the direction angles based on the distances, the received intensities, and an ultrasonic signal characteristic, the ultrasonic signal characteristic being a variation of a received intensity depending on a direction of a corresponding ultrasonic signal.

Upon two 3D positions of the ultrasonic signal receiver corresponding to the distances and the direction angles being estimated, the 3D position may be estimated to be within a predetermined area.

According to yet another aspect of one or more embodiments, there may be provided a 3D position estimation method, including measuring received intensities of ultrasonic signals received by an ultrasonic signal receiver, calculating direction angles of the ultrasonic signal receiver with respect to the ultrasonic signals, and estimating a 3D position of the ultrasonic signal receiver based on a fixed distance and the direction angles.

The calculating of the direction angles may include calculating the direction angles based on the fixed distance, the received intensities, and an ultrasonic signal characteristic, the ultrasonic signal characteristic being a variation of a received intensity depending on a direction of a corresponding ultrasonic signal.

Upon two 3D positions of the ultrasonic signal receiver corresponding to the fixed distance and the direction angles being estimated, the calculating of the 3D position may include estimating the 3D position to be within a predetermined area.

The estimating may include estimating the 3D position of the ultrasonic signal receiver as any one among left, right, up, and down based on a reference point on the fixed distance.

The method may further include sensing a predetermined repeated operation of moving left, right, up, and down within the fixed distance, to measure or correct in real time a relational expression between the predetermined repeated operation and one of the direction angles of the ultrasonic signal receiver prior to the estimating. The estimating of the 3D position may use the relational expression.

Additional aspects, features, and/or advantages of embodiments will be set forth in part in the description which follows and, in part, will be apparent from the description, or may be learned by practice of the disclosure.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 illustrates a configuration of a three-dimensional (3D) position estimation apparatus according to an embodiment;

FIG. 2 illustrates an ultrasonic signal characteristic of an ultrasonic signal that a received intensity of the ultrasonic signal varies according to a direction angle that is a received angle corresponding to a direction of the ultrasonic signal on a given distance;

FIG. 3 illustrates a relationship between a distance and an angle according to an ultrasonic signal characteristic, and an ultrasonic signal intensity according to an embodiment;

FIG. 4 illustrates an example of estimating a 3D position according to an embodiment;

FIG. 5 illustrates another example of estimating a 3D position according to an embodiment;

FIG. 6 illustrates a method of estimating a 3D position according to an embodiment; and

FIG. 7 illustrates a method of estimating a position of an ultrasonic signal receiver moving within a fixed distance according to an embodiment.

### DETAILED DESCRIPTION

Reference will now be made in detail to embodiments, examples of which are illustrated in the accompanying drawings, wherein like reference numerals refer to the like elements throughout. Embodiments are described below to explain the present disclosure by referring to the figures.

According to embodiments, there may be provided an apparatus and method that may calculate distances and direction angles between two ultrasonic signal transmitters and an ultrasonic signal receiver, and estimate a three-dimensional (3D) position of the ultrasonic signal receiver based on the calculated distances and direction angles.

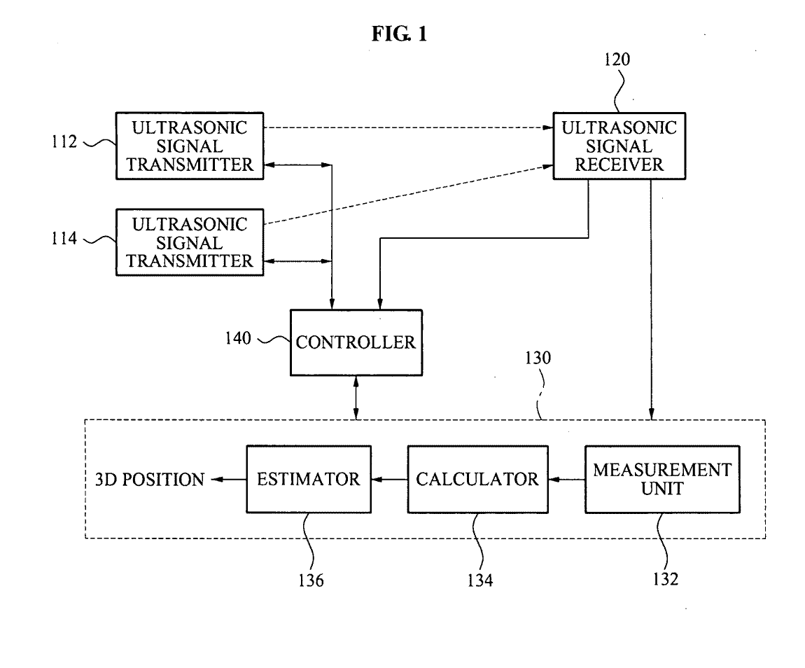

FIG. 1 illustrates a configuration of a 3D position estimation apparatus according to an embodiment. Referring to FIG. 1, the 3D position estimation apparatus includes a 3D position estimator 130 and a controller 140.

In FIG. 1, ultrasonic signal transmitters 112 and 114 are separated from an ultrasonic signal receiver 120. The 3D position estimation apparatus may include any one of the ultrasonic signal transmitters 112 and 114, and the ultrasonic signal receiver 120. The 3D position estimation apparatus may be constructed as an independent apparatus that is separate from the ultrasonic signal transmitters 112 and 114 or the ultrasonic signal receiver 120.

The ultrasonic signal transmitters 112 and 114 may transmit ultrasonic signals according to a control of the controller 140. The ultrasonic signal receiver 120 may receive the ultrasonic signals from the ultrasonic signal transmitters 112 and 114. The ultrasonic signal transmitters 112 and 114 may sequentially transmit the ultrasonic signals at predetermined time intervals, and may also simultaneously transmit the ultrasonic signals at different frequencies. When the ultrasonic signals of the different frequencies are simultaneously received, the ultrasonic signal receiver 120 may separate the received ultrasonic signals using a frequency filter (not shown).

The controller 140 may control a general operation of the 3D position estimation apparatus. The controller 140 may control the ultrasonic signal transmitters 112 and 114 to transmit the ultrasonic signals, and may transmit an ultrasonic signal transmission time to a measurement unit 132.

The 3D position estimator 130 may include the measurement unit 132, a calculator 134, and an estimator 136. The measurement unit 132 may measure time of flights (TOFs) of the ultrasonic signals received by the ultrasonic signal receiver 120, and received intensities of the ultrasonic signals.

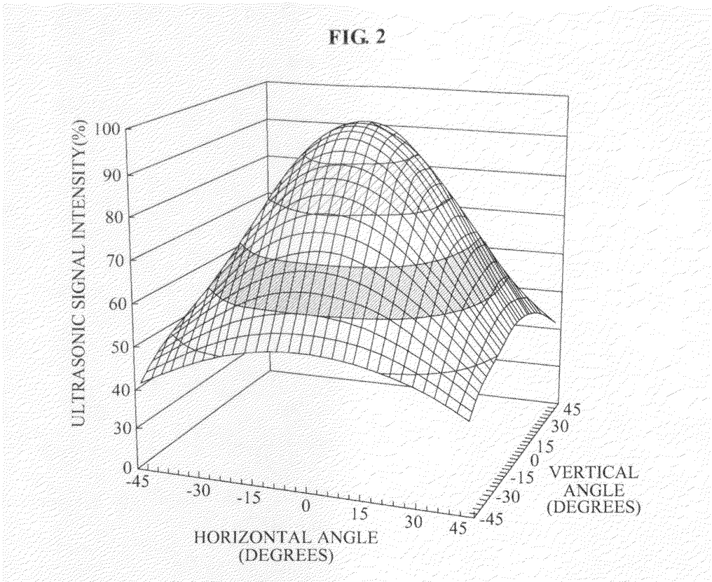

The calculator 134 may calculate distances between the ultrasonic signal transmitters 112 and 114, and the ultrasonic signal receiver 120, and may calculate direction angles of the ultrasonic signal receiver 120 with respect to the ultrasonic signals based on the distances, the received intensities, and an ultrasonic signal characteristic. The ultrasonic signal characteristic may be that a received intensity may vary according to a direction of a corresponding ultrasonic signal. The above ultrasonic signal characteristic may be expressed as shown in a graph of FIG. 2.

FIG. 2 illustrates an ultrasonic signal characteristic of an ultrasonic signal that a received intensity of the ultrasonic signal varies according to a direction angle that is a received angle corresponding to a direction of the ultrasonic signal based on a given distance. It can be known from the graph of FIG. 2 that the ultrasonic signal may have a characteristic that the received intensity of the ultrasonic signal may vary depending on the direction angle that is the received angle of the ultrasonic signal receiver 120 (FIG. 1) corresponding to the direction of the ultrasonic signal based on the given distance. In the following description, the ultrasonic signal characteristic indicating that the received intensity may vary depending on the direction of the ultrasonic signal, is referred to as a “directivity”.

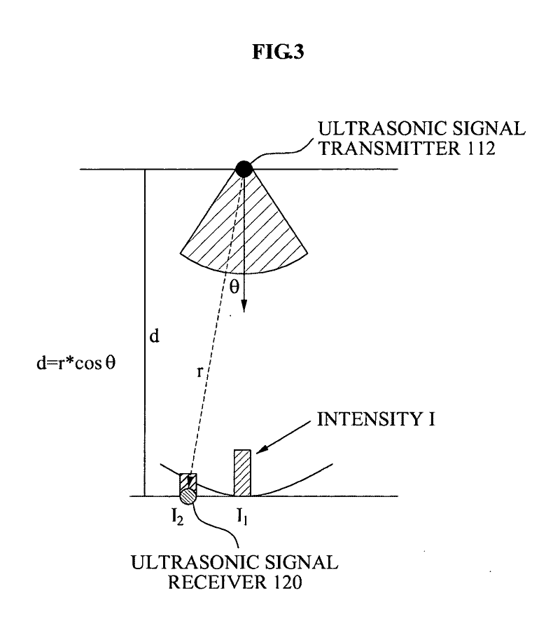

The calculator 134 (FIG. 1) may calculate direction angles of the ultrasonic signal receiver 120 (FIG. 1) as described below with reference to FIG. 3.

FIG. 3 illustrates a relationship between a distance and an angle according to an ultrasonic signal characteristic, and an ultrasonic signal intensity according to an embodiment. Referring to FIG. 3, an ultrasonic signal intensity I₁ within a predetermined distance with respect to an ultrasonic signal transmission direction may be in inverse proportion to a square of the distance. An ultrasonic signal intensity I₂ of the ultrasonic signal receiver 120 may be calculated using a directional function. The ultrasonic signal intensity I₁ and the ultrasonic signal intensity I₂ may be given, for example, by Equation 1, shown below.

I₁=k/d²

I₂=f(I₁,θ) Equation 1

Here, I₁ denotes the ultrasonic signal intensity within the predetermined distance with respect to the ultrasonic signal transmission direction, I₂ denotes the ultrasonic signal intensity measured by the ultrasonic signal receiver 120, k denotes a proportional factor that is determined empirically, d denotes a distance from the ultrasonic signal transmitter 112 to a measurement location of I₁, f( ) denotes a directivity function, and θ denotes a direction angle that is a received angle of the ultrasonic signal receiver 120 corresponding to the ultrasonic signal transmission direction.

The above ultrasonic signal strength I₁ within the predetermined distance with respect to the ultrasonic signal transmission direction corresponds to pre-verified information. When the 3D position estimation apparatus may measure an intensity to the ultrasonic signal transmission direction, d may be verified based on pre-calculated information. A distance from the ultrasonic signal transmitter 112 to the ultrasonic signal receiver 120 that may be measured based on the TOF may be expressed as r. Since d=r×cos θ, θ may be expressed using I₁ and r, as given, for example, by Equation 2, shown below.

$$θ = {cos}^{- 1} ( \frac{1}{r} \sqrt{\frac{k}{{I}_{1}}} ) \qquad Equation 2$$

Here, θ denotes the direction angle that is the received angle of the ultrasonic signal receiver 120 corresponding to the ultrasonic signal transmission direction, I₁ denotes the ultrasonic signal intensity within the predetermined distance with respect to the ultrasonic signal transmission direction, k denotes the proportional factor that is determined based on the experiment, and r denotes the distance from the ultrasonic signal transmitter 112 to the ultrasonic signal receiver 120.

When the ultrasonic signal intensity measured by the ultrasonic signal receiver 120 is I₂, θ may be expressed as a function of I₁ and θ due to the directivity, as given, for example, by the following Equation 3. Accordingly, θ may be calculated by solving simultaneous equations.

$${I}_{2} = f ( {I}_{1} , θ ) = f ( {I}_{1} , {cos}^{- 1} ( \frac{1}{r} \sqrt{\frac{k}{{I}_{1}}} ) ) \qquad Equation 3$$

Here, I₁ denotes the ultrasonic signal intensity within the predetermined distance with respect to the ultrasonic signal transmission direction, I₂ denotes the ultrasonic signal intensity measured by the ultrasonic signal receiver 120, k denotes the proportional factor that is determined based on the experiment, f( ) denotes the directivity function, θ denotes the direction angle that is the received angle of the ultrasonic signal receiver 120 corresponding to the ultrasonic signal transmission direction, and r denotes the distance from the ultrasonic signal transmitter 112 to the ultrasonic signal receiver.

The estimator 136 (FIG. 1) may estimate the 3D position of the ultrasonic signal receiver 120 based on the calculated distances and direction angles.

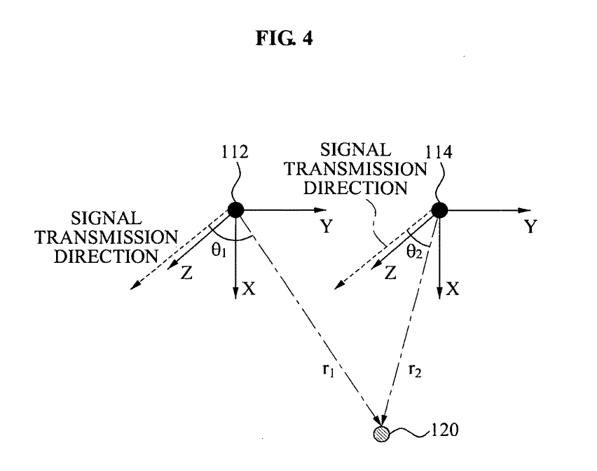

FIG. 4 illustrates an example of estimating a 3D position according to an embodiment. Referring to FIG. 4, the estimator 136 (FIG. 1) may estimate a 3D position that is a corresponding condition, based on two distances between the ultrasonic signal transmitters 112 and 114 and the ultrasonic signal receiver 120, and also based on two direction angles θ₁ and θ₂ that are received angles of the ultrasonic signal receiver 120.

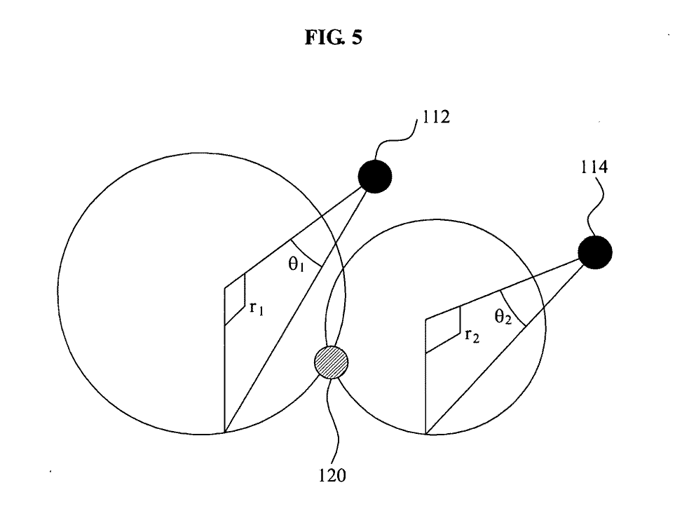

However, due to a directivity of ultrasonic signals, an ultrasonic signal intensity may have a symmetry and thus the estimator 136 (FIG. 1) may estimate two 3D positions, which will be described with reference to FIG. 5.

FIG. 5 illustrates another example of estimating a 3D position according to an embodiment. It can be seen from FIG. 5 that two circles intersect at two 3D positions.

To solve the above matter that the two 3D positions are sensed, a measurement area may be predetermined so that a direction of the ultrasonic signal transmitters 112 and 114 may be directed in either an upper direction or a lower direction at all times.

Accordingly, when the two 3D positions are estimated, the estimator may select a 3D position with the predetermined measurement area.

The 3D position estimation apparatus according to an embodiment may be installed in a small device such as a portable device. In this case, due to a characteristic of the small device, a distance between each of the ultrasonic signal transmitters 112 and 114, and the ultrasonic signal receiver 120 may be insufficient to be measured using a TOF.

Accordingly, only when the ultrasonic signal receiver 120 moves within a fixed distance that is a predetermined distance range may the 3D position of the ultrasonic signal receiver 120 be estimated.

Referring to FIGS. 1 and 5, when the ultrasonic signal receiver 120 positioned within the fixed distance receives ultrasonic signals, the measurement unit 132 may measure intensities of the ultrasonic signals.

The calculator 134 may calculate direction angles of the ultrasonic signal receiver 120 based on the fixed distance, the intensities, and an ultrasonic signal characteristic where a received intensity varies depending on a direction of a corresponding ultrasonic signal.

The estimator 136 may estimate a position of the ultrasonic signal receiver 120 based on the calculated distances and direction angles.

The estimator 136 may sense a predetermined repeated operation of moving left, right, up, and down within the fixed distance to measure or correct in real time a relational expression between the repeated operation and a direction angle of the ultrasonic signal receiver 120 prior to the estimating, and may estimate the 3D position of the ultrasonic signal receiver 120 using the relational expression.

Here, since the fixed distance is a predetermined distance range, the estimator 136 may estimate the 3D position of the ultrasonic signal receiver 120 as any one among up, down, left, and right, based on a reference point on the fixed distance, instead of estimating an accurate 3D position.

A scheme of estimating a 3D position using two ultrasonic signal transmitters is described above, however, embodiments are not limited thereto. Specifically, even when two or more ultrasonic signal transmitters exist, the 3D position may be estimated using the same scheme.

Hereinafter, a method of estimating a 3D position based on ultrasonic signals will be described with reference to the accompanying drawings.

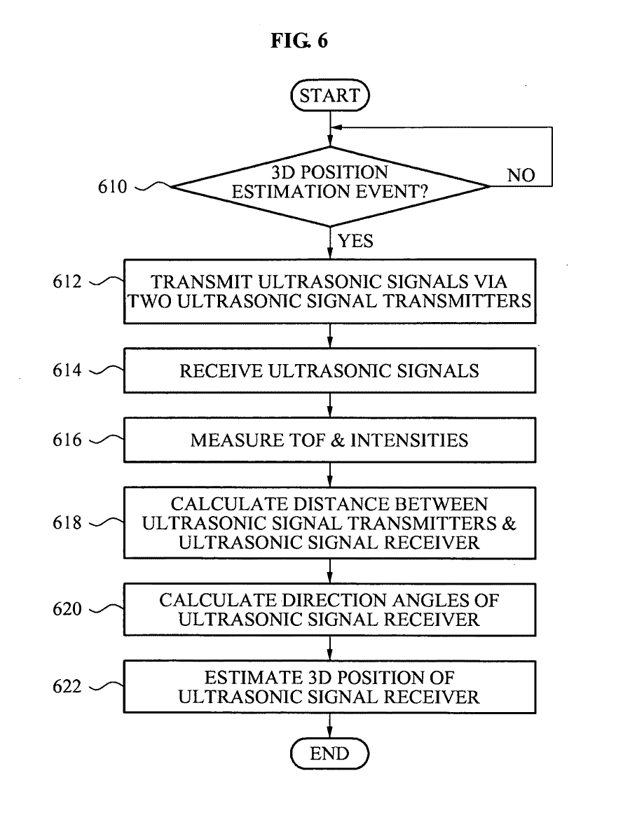

FIG. 6 illustrates a method of estimating a 3D position according to an embodiment.

Referring to FIG. 6, when a 3D position estimation event is sensed in operation 610, a 3D position estimation apparatus may transmit ultrasonic signals via two ultrasonic signal transmitters in operation 612. Otherwise, operation 610 may be repeatedly performed until a 3D position estimation event is sensed. In operation 614, the 3D position estimation apparatus may receive two ultrasonic signals via an ultrasonic signal receiver.

In operation 616, the 3D position estimation apparatus may measure TOFs and intensities of the two ultrasonic signals.

In operation 618, the 3D position estimation apparatus may calculate distances between the two ultrasonic signal transmitters and the ultrasonic signal receiver based on the TOFs. In operation 620, the 3D position estimation apparatus may calculate direction angles of the ultrasonic signal receiver based on the calculated distances, the intensities, and an ultrasonic signal characteristic that a received strength varies according to a direction of a corresponding ultrasonic signal.

In operation 622, the 3D position estimation apparatus may estimate the 3D position of the ultrasonic signal receiver based on distances between the two ultrasonic signal transmitters and the ultrasonic signal receiver, and the direction angles. When estimating the 3D position of the ultrasonic signal receiver, two 3D positions of the ultrasonic signal receiver may be estimated. In this case, a 3D position within a predetermined area may be estimated as the 3D position of the ultrasonic signal receiver.

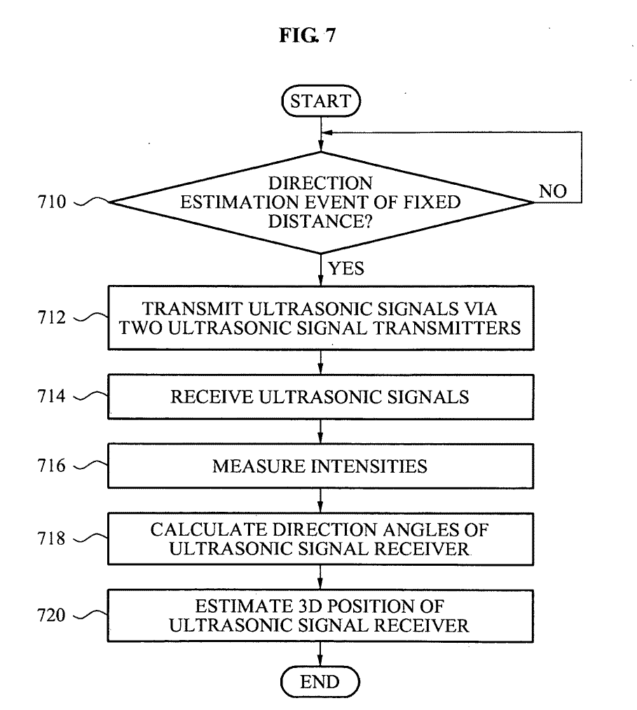

FIG. 7 illustrates a method of estimating a position of an ultrasonic signal receiver moving within a fixed distance according to an embodiment.

Referring to FIG. 7, when a direction estimation event of a fixed distance occurs in operation 710, a 3D position estimation apparatus may transmit ultrasonic signals via two ultrasonic signals in operation 712. Otherwise operation 710 may be repeated until a direction estimation event of a fixed distance occurs. The 3D position estimation apparatus may receive two ultrasonic signals via an ultrasonic signal receiver in operation 714.

In operation 716, the 3D position estimation apparatus may measure intensities of the two ultrasonic signals. In operation 718, the 3D position estimation apparatus may calculate direction angles of the ultrasonic signal receiver based on the fixed distance, the intensities, and an ultrasonic signal characteristic, the ultrasonic signal characteristic being a variance of a received strength according to a direction of a corresponding ultrasonic signal.

In operation 720, the 3D position estimation apparatus may estimate a 3D position of the ultrasonic signal receiver based on the fixed distance and the direction angles. When estimating the 3D position of the ultrasonic signal receiver, two 3D positions of the ultrasonic signal receiver may be estimated. In this case, a 3D position within a predetermined area may be estimated as the 3D position of the ultrasonic signal receiver.

The method for estimating position using ultrasonic signals according to the above-described example embodiments may also be implemented through computer readable code/instructions in/on a medium, e.g., a computer readable medium, to control at least one processing element to implement any above described embodiment. The medium can correspond to medium/media permitting the storing or transmission of the computer readable code.

The computer readable code can be recorded or transferred on a medium in a variety of ways, with examples of the medium including recording media, such as magnetic storage media (e.g., ROM, floppy disks, hard disks, etc.) and optical recording media (e.g., CD-ROMs, or DVDs), and transmission media. The media may also be a distributed network, so that the computer readable code is stored or transferred and executed in a distributed fashion. Still further, as only an example, the processing element could include a processor or a computer processor, and processing elements may be distributed or included in a single device.

In addition to the above described embodiments, example embodiments can also be implemented as hardware, e.g., at least one hardware based processing unit including at least one processor capable of implementing any above described embodiment.

Although a few embodiments have been shown and described, it would be appreciated by those skilled in the art that changes may be made in these embodiments without departing from the principles and spirit of the disclosure, the scope of which is defined by the claims and their equivalents.

What is claimed is:

1. A three-dimensional (3D) position estimation apparatus, comprising:
a measurement unit to measure time of flights of ultrasonic signals received by an ultrasonic signal receiver, and received intensities of the ultrasonic signals;
a calculator to calculate distances corresponding to the time of flights, and to calculate direction angles of the ultrasonic signal receiver with respect to the ultrasonic signals; and
an estimator to estimate a 3D position of the ultrasonic signal receiver based on the distances and the direction angles.

2. The apparatus of claim 1, further comprising:
a plurality of ultrasonic signal transmitters to sequentially transmit the ultrasonic signals at predetermined time intervals.

3. The apparatus of claim 1, further comprising:
a plurality of ultrasonic signal transmitters to simultaneously transmit the ultrasonic signals at different frequencies,
wherein the ultrasonic signal receiver receives the simultaneously transmitted ultrasonic signals and separates the received ultrasonic signals using a frequency filter.

4. The apparatus of claim 1, wherein the calculator calculates the direction angles based on the distances, the received intensities, and an ultrasonic signal characteristic, the ultrasonic signal characteristic being a variation of a received intensity depending on a direction of a corresponding ultrasonic signal.

5. The apparatus of claim 1, wherein, upon two 3D positions of the ultrasonic signal receiver corresponding to the distances and the direction angles being estimated, the estimator estimates the 3D position to be within a predetermined area.

6. A 3D position estimation apparatus, comprising:
a measurement unit to measure received intensities of ultrasonic signals received by an ultrasonic signal receiver;
a calculator to calculate direction angles of the ultrasonic signal receiver with respect to the ultrasonic signals; and
an estimator to estimate a 3D position of the ultrasonic signal receiver based on a fixed distance and the direction angles.

7. The apparatus of claim 6, further comprising:
a plurality of ultrasonic signal transmitters to sequentially transmit the ultrasonic signals at predetermined time intervals.

8. The apparatus of claim 6, further comprising:
a plurality of ultrasonic signal transmitters to simultaneously transmit the ultrasonic signals at different frequencies,
wherein the ultrasonic signal receiver receives the simultaneously transmitted ultrasonic signals and separates the received ultrasonic signals using a frequency filter.

9. The apparatus of claim 6, wherein the calculator calculates the direction angles based on the fixed distance, the received intensities, and an ultrasonic signal characteristic, the ultrasonic signal characteristic being a variation of a received intensity depending on a direction of a corresponding ultrasonic signal.

10. The apparatus of claim 6, wherein, upon two 3D positions of the ultrasonic signal receiver corresponding to the fixed distance and the direction angles being estimated, the estimator estimates the 3D position to be within a predetermined area.

11. The apparatus of claim 6, wherein the estimator estimates the 3D position of the ultrasonic signal receiver as any one among left, right, up, and down based on a reference point on the fixed distance.

12. The apparatus of claim 6, wherein the estimator senses a predetermined repeated operation of moving left, right, up, and down within the fixed distance, to measure or correct in real time a relational expression between the predetermined repeated operation and one of the direction angles of the ultrasonic signal receiver prior to the estimating, and estimates the 3D position of the ultrasonic signal receiver using the relational expression.

13. A 3D position estimation method, comprising:
measuring time of flights of ultrasonic signals received by an ultrasonic signal receiver, and received intensities of the ultrasonic signals;
calculating distances corresponding to the time of flights;
calculating direction angles of the ultrasonic signal receiver with respect to the ultrasonic signals; and
estimating a 3D position of the ultrasonic signal receiver based on the distances and the direction angles.

14. The method of claim 13, wherein the calculating of the direction angles comprises calculating the direction angles based on the distances, the received intensities, and an ultrasonic signal characteristic, the ultrasonic signal characteristic being a variation of a received intensity depending on a direction of a corresponding ultrasonic signal.

15. The method of claim 13, wherein, upon two 3D positions of the ultrasonic signal receiver corresponding to the distances and the direction angles being estimated, the 3D position is estimated to be within a predetermined area.

16. A 3D position estimation method, comprising:
measuring received intensities of ultrasonic signals received by an ultrasonic signal receiver;
calculating direction angles of the ultrasonic signal receiver with respect to the ultrasonic signals; and
estimating a 3D position of the ultrasonic signal receiver based on a fixed distance and the direction angles.

17. The method of claim 16, wherein the calculating of the direction angles comprises calculating the direction angles based on the fixed distance, the received intensities, and an ultrasonic signal characteristic, the ultrasonic signal characteristic being a variation of a received intensity depending on a direction of a corresponding ultrasonic signal.

18. The method of claim 16, wherein, upon two 3D positions of the ultrasonic signal receiver corresponding to the fixed distance and the direction angles being estimated, the calculating of the 3D position comprises estimating the 3D position to be within a predetermined area.

19. The method of claim 16, wherein the estimating comprises estimating the 3D position of the ultrasonic signal receiver as any one among left, right, up, and down based on a reference point on the fixed distance.

20. The method of claim 16, further comprising:
sensing a predetermined repeated operation of moving left, right, up, and down within the fixed distance, to measure or correct in real time a relational expression between the predetermined repeated operation and one of the direction angles of the ultrasonic signal receiver prior to the estimating,
wherein the estimating of the 3D position uses the relational expression.
